(19) United States
(12) Patent Application Publication
(10) Pub. No.: US 2005/0052483 A1
(43) Pub. Date: Mar. 10, 2005

(54) Inkjet recording system and inkjet recording method

(75) Inventors: Takahiro Esaki, Fukuoka (JP); Yutaka Miyazono, Fukuoka (JP); Hidetoshi Matsuo, Saga (JP); Hiroshi Hattori, Fukuoka (JP); Seiji Nakagawa, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/930,783

(22) Filed: Sep. 1, 2004

(30) Foreign Application Priority Data
Sep. 9, 2003 (JP) 2003-316481

(51) Int. Cl. B41J 29/38

(52) U.S. Cl. 347/12

(57) ABSTRACT

A recording system includes a line head having a plurality of nozzles arranged in a Y direction, a LF motor for feeding a role sheet in an X direction, and a CR motor for shifting a set position of the line head sequentially. When the set position of the line head is shifted by a given distance in the Y direction, the recording system converts image data in such a manner that an image is shifted in an opposite direction by a distance equal to the given distance so that the same image is recorded in different positions of the nozzles.

### CROSS REFERENCE TO RELATED APPLICATIONS

This Non-provisional application claims priority under 35 U.S.C. §119(a) on patent application Ser. No. 2003-316481 filed in Japan on Sep. 9, 2003, the entire contents of which are hereby incorporated by reference.

### BACKGROUND OF THE INVENTION

The present invention relates to an inkjet recording system equipped with an inkjet recording head, and an inkjet recording method.

In order to issue a large number of vouchers in a short period of time, border lines and letters included as the contents of the vouchers are continuously printed on recording paper. In mass production of, for example, read-only CD-ROM disks and DVD-ROM disks, images such as letters and graphics have conventionally been repeatedly and continuously printed on the faces of these disks.

Conventionally, the aforementioned kind of printing has been performed by using a screen printer or an offset printer dedicated to this purpose (see, for example, Japanese Laid-Open Patent Publication No. 2002-230841).

The screen printing or the offset printing, however, requires considerable time and cost for creating a printing block and adjusting colors. Also, in the case where contents to be printed are to be changed, the printer should be once stopped and the printing setting should be reset from the beginning. Therefore, the fabrication of the DVD-ROM cannot help stopping for a long period of time.

Alternatively, with respect to the printing of vouchers, ruled lines and border lines included in the contents of the vouchers are common to all the vouchers but the names of clients and the like to be printed in the respective vouchers are different. In other words, most of the printing contents are common to all the vouchers but merely part of the contents is different among the vouchers. Therefore, when the screen printing or the offset printing is employed, merely the printing contents common to all the vouchers are printed, and a part of the printing contents different among the vouchers should be printed by using another printing means.

As a countermeasure, an inkjet recording apparatus can be comparatively inexpensively fabricated, and the printing setting can be easily and rapidly reset by changing image data to be supplied to an inkjet recording head included in the inkjet recording apparatus. Also, merely a part of the printing contents can be comparatively easily changed.

In the case where one and the same image is recorded on a large scale by using the inkjet recording apparatus, the following problems occur:

The lifetime of the inkjet recording head depends upon the numbers of times of discharging an ink (hereinafter referred to as the discharging frequencies) of nozzles, and hence, when the discharging frequency exceeds a given value, the recording head cannot exhibit desired performance. The discharging frequency of each nozzle of the recording head depends upon the contents of an image to be recorded, and hence, in one recording head, some nozzles have large discharging frequencies and the other nozzles have small discharging frequencies. Therefore, in recording the same image on a large scale, a large difference can be easily caused in the discharging frequency among the nozzles.

It is assumed that a line head 110 having a plurality of nozzles 111 vertically arranged is used for recording a letter “A” and a border line 115 surrounding the letter on recording paper 106 as shown in FIG. 19. In this case, as shown in FIG. 19, although the nozzle 111a used for recording the border line 115 extending along the lateral direction discharges the ink as frequently as 46 times, most of the other nozzles discharge the ink 4 times or less. Thus, there is large dispersion in the discharging frequency among the nozzles.

When the lifetime of any nozzle of a line head is over, the line head cannot exhibit the initial performance as a whole, and hence, the lifetime of the line head is over. Therefore, when the lifetime of any nozzle is over, it is necessary to once stop the fabrication of DVD-ROMs or the creation of vouchers for exchanging the line head. In the setting of a line head, however, the positioning should be adjusted with accuracy of the order of micrometer. Therefore, the exchange of the line head requires a lot of time and labor. Accordingly, in order to improve efficiency in the fabrication of DVD-ROMs or the creation of vouchers, it is desired to elongate the lifetime of the line head as much as possible so as to reduce the number of times of exchanging the line head.

However, when there is large dispersion in the discharging frequency among the nozzles in this manner, time elapsed until the discharging frequency of a specific nozzle reaches its lifetime frequency is short. Therefore, the number of times of exchanging the line head is increased, and hence, it may take a long period of time to complete the fabrication of DVD-ROMs or the creation of vouchers. Also, even when the discharging frequencies of a large number of nozzles are small as compared with their lifetime frequencies, the whole line head should be discarded, and therefore, it is difficult to efficiently use the line head.

### SUMMARY OF THE INVENTION

The present invention was devised in consideration of the aforementioned conventional problems, and an object of the invention is, in the case where the same image or substantially the same image is recorded plural times by using an inkjet recording head, elongating the lifetime of the recording head and improving the efficiency of use of the recording head.

The inkjet recording system of this invention includes: an inkjet recording head having a plurality of nozzles arranged along a first direction; a moving mechanism for supporting the recording head and/or a recording medium and moving the recording head and the recording medium relatively to each other along a second direction not parallel to the first direction in a recording operation; a controller for accepting image data for recording an image by allowing the nozzles of the recording head to discharge an ink and for controlling the recording head and the moving mechanism for recording the image on the recording medium; and an image data converter for converting the image data, wherein the image is recorded by a nozzle combination of which nozzles are a part of the nozzles that the inkjet recording head has and which includes nozzles arranged in a string along the first direction, the image data converter converts the image data so as to shift a position of the nozzle combination along the first direction, and the controller accepts the converted image data and controls the recording head for recording the image with the position of the nozzle combination shifted along the first direction.

In the aforementioned recording system, the image data converter converts the image data and the recording head can record the image shifted along the first direction corresponding to the direction for arranging at least the nozzles on the basis of the converted image data. Accordingly, in the case where the same or substantially the same (hereinafter simply referred to as the same) image is recorded on a large scale, the position of the nozzle combination used for recording the image can be appropriately changed by appropriately shifting the image. As a result, the use frequencies of the nozzles can be more averaged, and the dispersion of the discharging frequencies among the nozzles can be reduced. Accordingly, the lifetime of the recording head can be elongated and the recording head can be efficiently used.

Other objects of the invention will become apparent to those skilled in the art from the following detailed description taken in connection with the accompanying drawings.

### BRIEF DESCRIPTION OF THE DRAWINGS

FIG. 1 is a perspective view of a recording apparatus;

FIG. 2 is a block diagram of a control system of the recording system;

FIG. 3 is a schematic plan view of a line head;

FIG. 4 is a plan view of a unit head;

FIG. 5 is a schematic diagram for showing the positional relationship in relative movement between a line head and a role sheet;

FIG. 6 is a schematic diagram for explaining movement of a role sheet;

FIG. 7 is a diagram of an image and a graph for showing discharging frequencies of respective nozzles necessary for recording the image;

FIG. 8 is a diagram for showing the relative position of a line head against a roll sheet;

FIG. 9 is a diagram for showing the relative position of the roll sheet against the line head;

FIG. 10 is a diagram for showing an image, the position of a line head and average discharging frequencies of respective nozzles in recording the image in exemplified recording of Embodiment 1;

FIG. 11 is a diagram for showing an image, the position of the line head and average discharging frequencies of respective nozzles in recording the image in another exemplified recording of Embodiment 1;

FIG. 12 is a diagram for explaining conversion of image data according to Embodiment 2;

FIG. 13 is a flowchart of a recording operation according to Embodiment 2;

FIG. 14 is a diagram for showing an image, the position of a line head and average discharging frequencies of respective nozzles in recording the image in exemplified recording in which the image is rotated;

FIG. 15 is a graph for showing average discharging frequencies of respective nozzles in the recording operation of Embodiment 2;

FIG. 16 is a plan view of a modified recording head;

FIG. 17 is a plan view of another modified recording head;

FIG. 18 is a schematic diagram for showing the positional relationship between a line head and a roll sheet; and

FIG. 19 is a diagram for showing an image and discharging frequencies of nozzles necessary for recording the image.

### DETAILED DESCRIPTION OF THE INVENTION

Now, preferred embodiments of the invention will be described with reference to the accompanying drawings.

### Embodiment 1

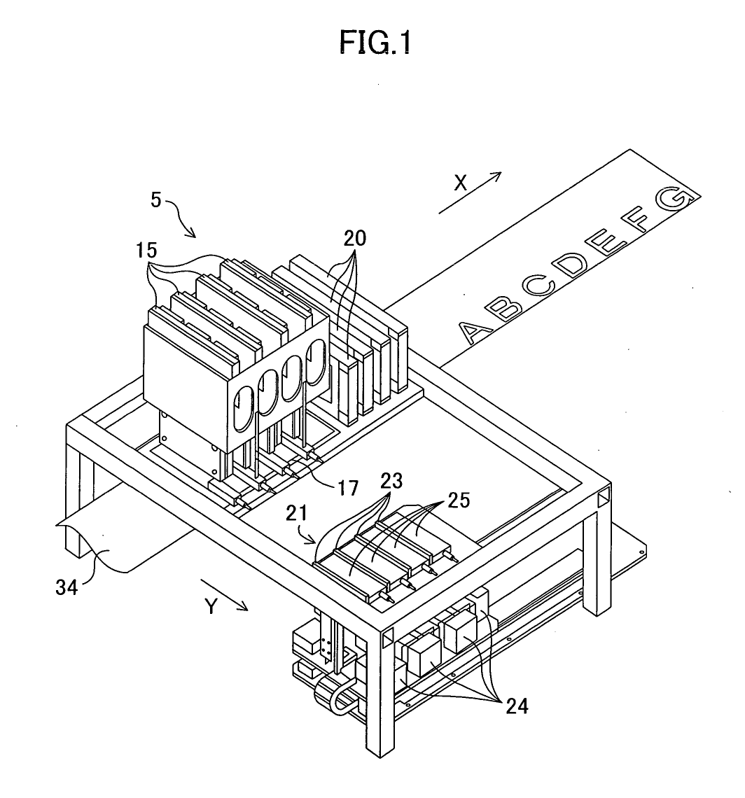

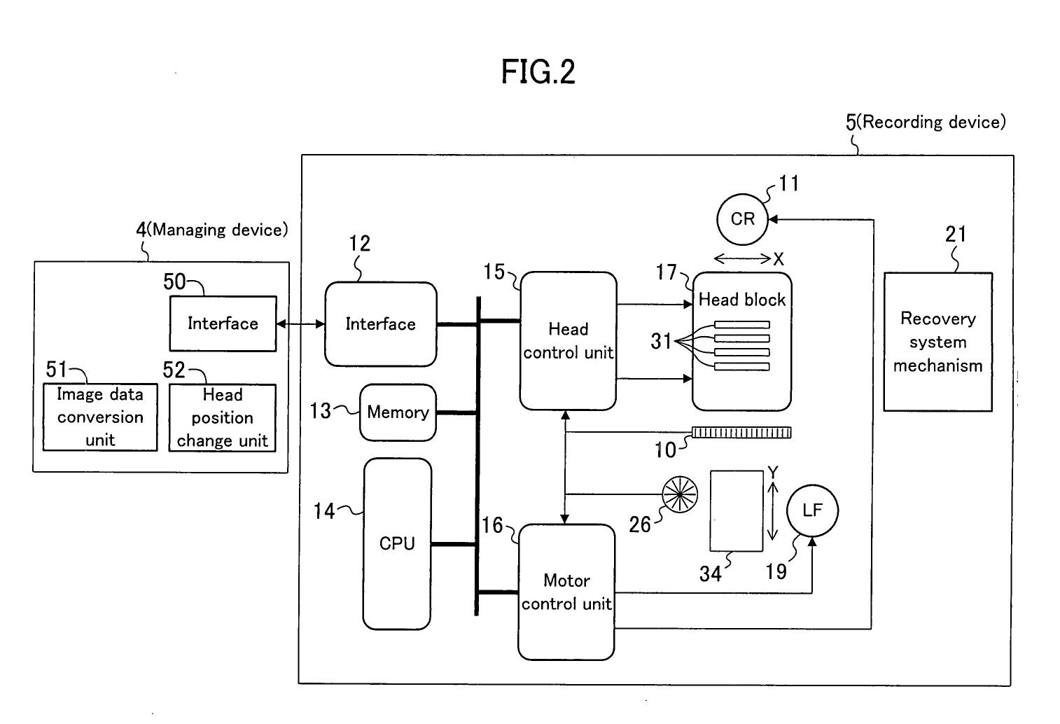

As shown in FIG. 1, an inkjet recording system according to Embodiment 1 includes a recording device 5 having four inkjet line heads 31 (shown in FIG. 2), so as to form a color image by combining inks of four colors of yellow (Y), cyan (C), magenta (M) and black (Bk). It is noted that an image herein includes one or more of a letter, a line, a symbol, a picture, a photo and the like.

The recording device 5 includes a head control unit 15 for controlling each line head 31, a head block 17 for positioning and fixing all the line heads 31, an ink tank 20 and a recovery system mechanism 21.

The recovery system mechanism 21 recovers the performance of each line head 31 and makes each line head 31 exhibit predetermined performance by performing capping for preventing head nozzle faces from drying and a recovery operation for the heads (such as an operation for forcedly discharging an ink or a purging operation). The recovery system mechanism 21 includes caps 25 for covering the nozzles of the line heads 31, blades 23 and pumps 24.

The head block 17 is transferred along a Y direction by a CR (carriage) motor 11 (not shown in FIG. 1 but shown in FIG. 2), so as to be movable between a position where the line heads 31 perform the recording (namely, a recording position) and a position above the recovery system mechanism 21. Also, the head block 17 is finely moved by the CR motor 11 along the Y direction, so as to finely adjust its position along the Y direction in the vicinity of the recording position.

In this embodiment, a roll sheet 34 is used as a recording medium. The roll sheet 34 extends from a roll not shown along an X direction so as to be continuously fed along the X direction by an LF (line feed) motor 19 (not shown in FIG. 1 but shown in FIG. 2). It is noted that the X direction is perpendicular to the Y direction.

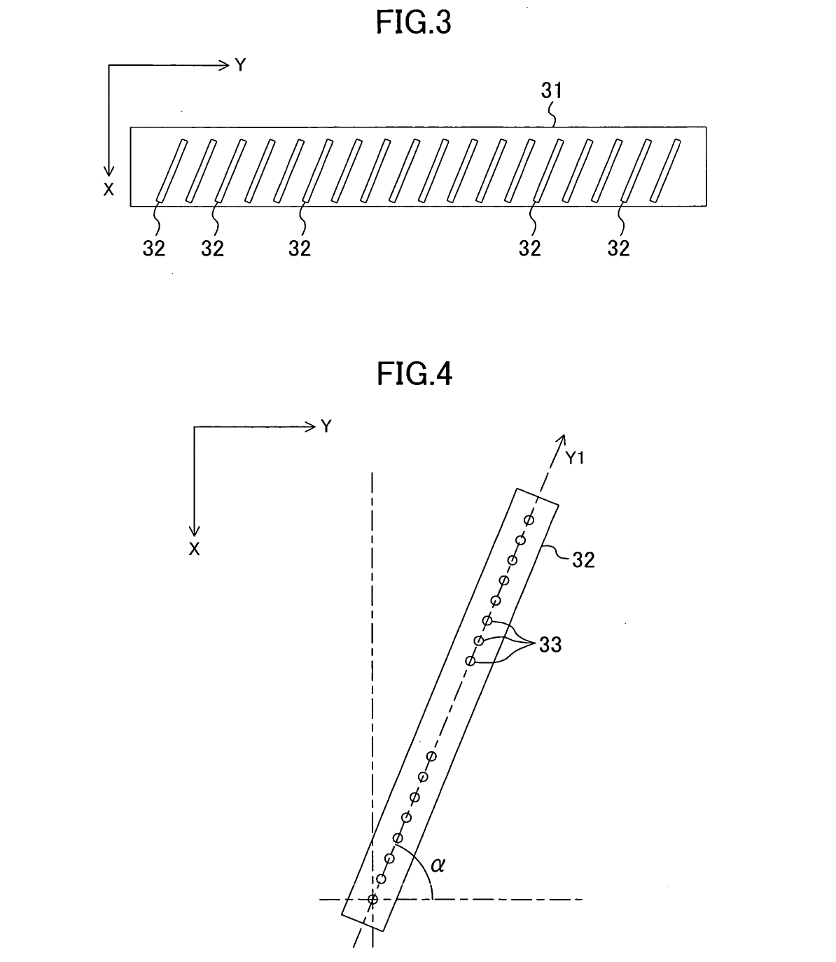

The line head 31 is not particularly specified in its shape and kind as far as it has a plurality of nozzles arranged along the Y direction on at least a part thereof. In this embodiment, the structure of the recording head is devised for improving the resolution. Specifically, as shown in FIGS. 3 and 4, the line head 31 of each color is constructed by combining a plurality of unit heads 32 each having a plurality of linearly arranged nozzles 33. More specifically, in each line head 31, a plurality of unit heads 32 inclined against the X direction and parallel to one another are arranged along a Y direction perpendicular to the X direction. Owing to this structure, the density of the nozzles of each line head 31 is increased, so as to improve the resolution.

As shown in FIG. 4, each unit head 32 includes 200 nozzles 33 arranged at a pitch of 133.9 μm. The nozzles 33 are linearly arranged so that the linear arrangement direction Yl can be inclined against the Y direction by a given angle α. In this embodiment, the angle α is set to 71.6 degrees. Thus, each line head 31 has a length (along the Y direction) of 220 mm, has 5200 nozzles in total, and has resolution along the X direction of 200 dpi (with a pitch of 127 μm) and resolution along the Y direction of 600 dpi (with a pitch of 42.33 μm).

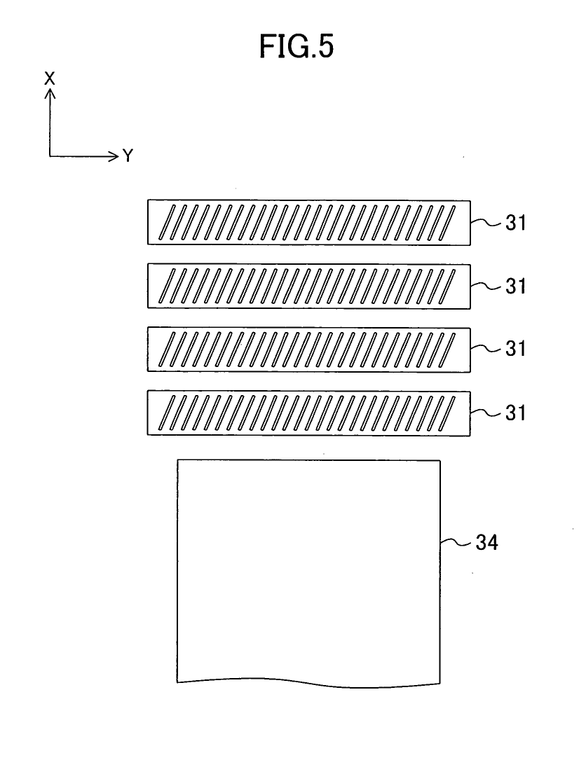

As shown in FIG. 5, the line heads 31 of the respective colors are arranged to extend along the Y direction and adjacent to one another along the X direction. In other words, the line heads 31 are arranged along a direction perpendicular to the direction of the relative movement between the line heads 31 and the roll sheet 34. As described above, the line heads 31 are positioned and fixed by the head block 17, and thus, the positional relationship among the line heads 31 is adjusted.

Next, referring to FIG. 2, a control system of this recording system will be described. This recording system includes, in addition to the recording device 5, a managing device 4. The recording device 5 includes an interface unit 12 for sending/receiving image data and various control commands to/from the managing device 4, a memory 13 for storing the image data and a control program, a CPU 14 serving as a control unit for controlling the whole recording device 5, a head control unit 15 for controlling the respective line heads 31, a motor control unit 16 for controlling the CR motor 11 and the LF motor 19, a linear encoder 10 for detecting the position of the head block 17, and a rotary encoder 26 for detecting the fed position of the roll sheet 34 and generating a pulse used as a reference in the control performed by the motor control unit 16 and the head control unit 15.

The managing device 4 includes an interface unit 50, an image data conversion unit 51 and a head position change unit 52. The image data conversion unit 51 and the head position change unit 52 are not particularly specified in their specific structures as far as they can exhibit functions described below. The image data conversion unit 51 and the head position change unit 52 may be constructed in the form of hardware or software.

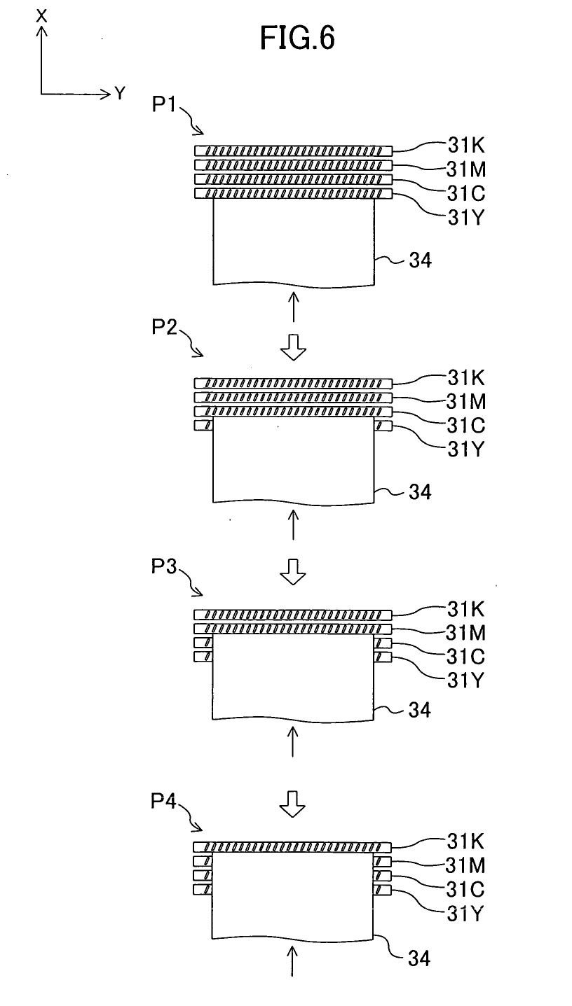

Next, the basic recording operation of the recording device 5 will be described with reference to FIGS. 2 and 6. First, a recording instruction signal including image data is sent from the managing device 4 to the recording device 5. When the recording instruction signal is received, the CPU 14 stores the received image data in the memory 13, performs the image processing and processing for permutating data in accordance with the positions of the nozzles of the heads 31 as well as initialization processing for the head control unit 15 and the motor control unit 16.

As the initialization processing, for example, the capping for preventing the head nozzle faces from drying is cancelled, the head nozzle faces are cleaned, a reference voltage of an amplifier for supplying a head driving waveform is set, the reference origin of a recording medium transfer mechanism including the LF motor 19 is set and a control parameter is set. Also, as the initialization processing, prior to a recording operation, the inks may be forcedly discharged from the nozzles for refreshing the inks standing in the vicinity of the nozzle tips or actuators of the heads may be driven for meniscus vibrating the inks contained in the nozzles.

After completing such initialization processing, the motor control unit 16 drives the LF motor 19, so as to convey the role sheet 34. As shown in FIG. 6, the role sheet 34 moves to reach the line head 31Y for discharging the yellow ink, the line head 31C for discharging the cyan ink, the line head 31M for discharging the magenta ink and the line head 31K for discharging the black ink in this order (see positions P1 through P4 of FIG. 4). The head control unit 15 drives actuators (not shown) of the respective line heads 31Y, 31C, 31M and 31K on the basis of the image data, and the respective line heads 31Y, 31C, 31M and 31K discharge the inks of the respective colors, so as to form a desired image on the roll sheet 34. This recording operation is continuously performed, and hence, the desired image is repeatedly recorded on the roll sheet. Then, when the image is recorded a predetermined number of times, the head control unit 15 terminates the discharging operation of the line heads 31.

After terminating the discharging operation, the motor control unit 16 drives the CR motor 11, so as to move the line heads 31 toward the recovery system mechanism 21. Thereafter, the recovery system mechanism 21 cleans the head nozzles faces, caps the head nozzles for preventing drying and the like (i.e., performs the recovery operation). Thus, the line heads 31 are restored to a state prior to the start of the recording operation.

The recovery operation of the line heads 31 may be appropriately performed during the sequential recording operation. Specifically, after recording the image a given number of times, the recording operation is once halted to perform the recovery operation, and then the recording operation is resumed. In the case where the instructed number of times of recording is very large, such a recovery operation is preferably appropriately performed during the sequential recording operation.

In the recording system of this embodiment, in addition to the aforementioned basic operation, the image data is converted so as to shift the image to be recorded along the Y direction and the position of the head block 17 is shifted along the Y direction in accordance with the conversion, so that the same image can be recorded by using a different combination of nozzles on the basis of the converted image data. Next, the conversion of the image data and the recording operation on the basis of the converted image data will be described.

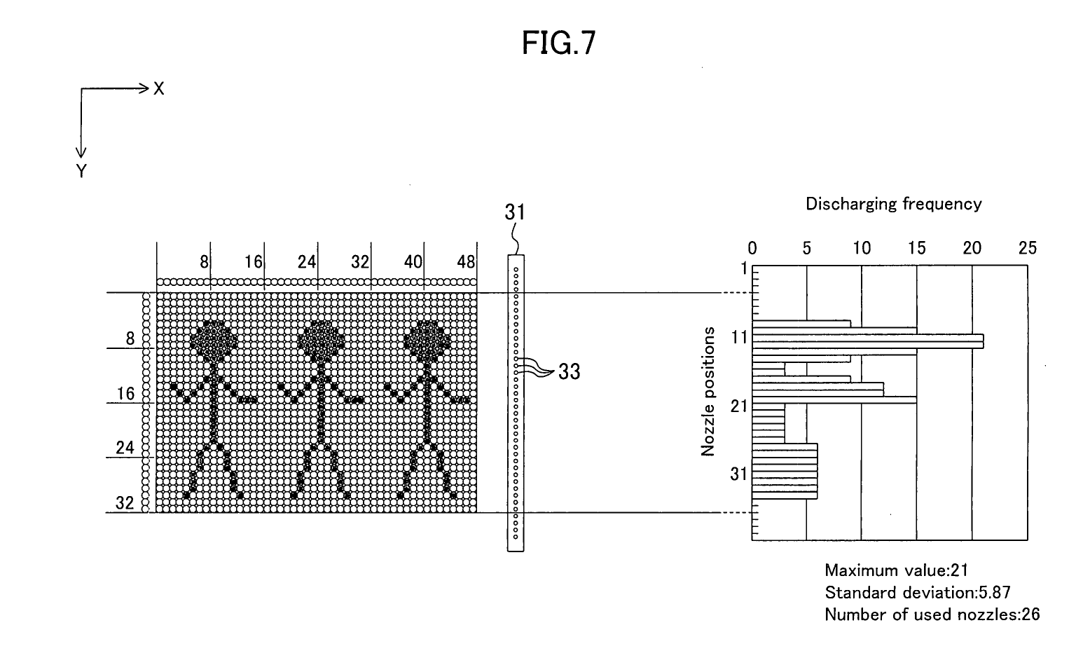

It is herein assumed that an image as shown in FIG. 7 is recorded as an example of the image to be recorded. In this example, it is assumed that the size of an image region (the maximum recordable region) corresponds to the size of 32×48 ink dots, and that each line head 31 has linearly arranged 40 nozzles 33. In FIG. 7, a graph for showing the discharging frequencies of the respective nozzles 33 necessary for recording the image is also shown.

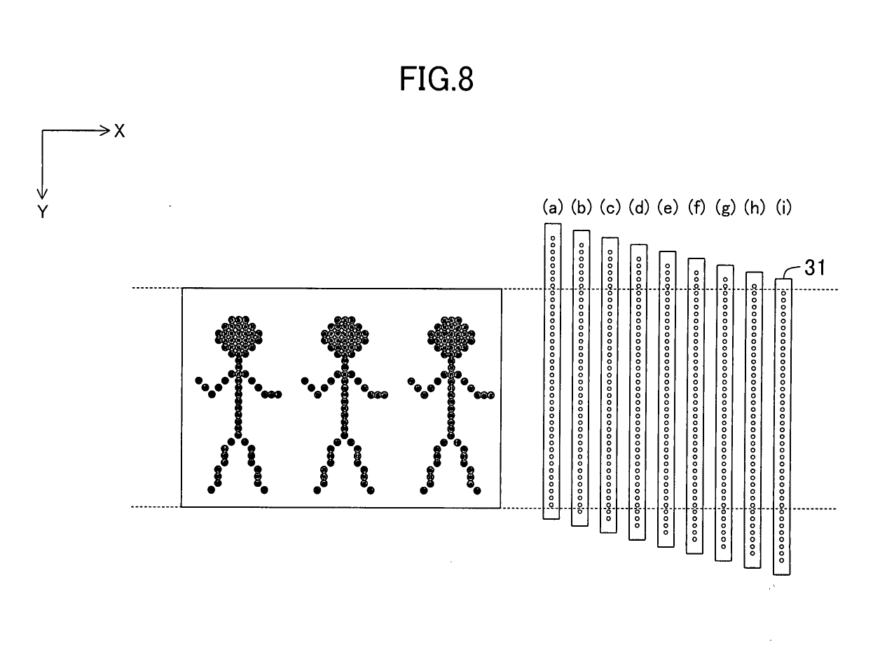

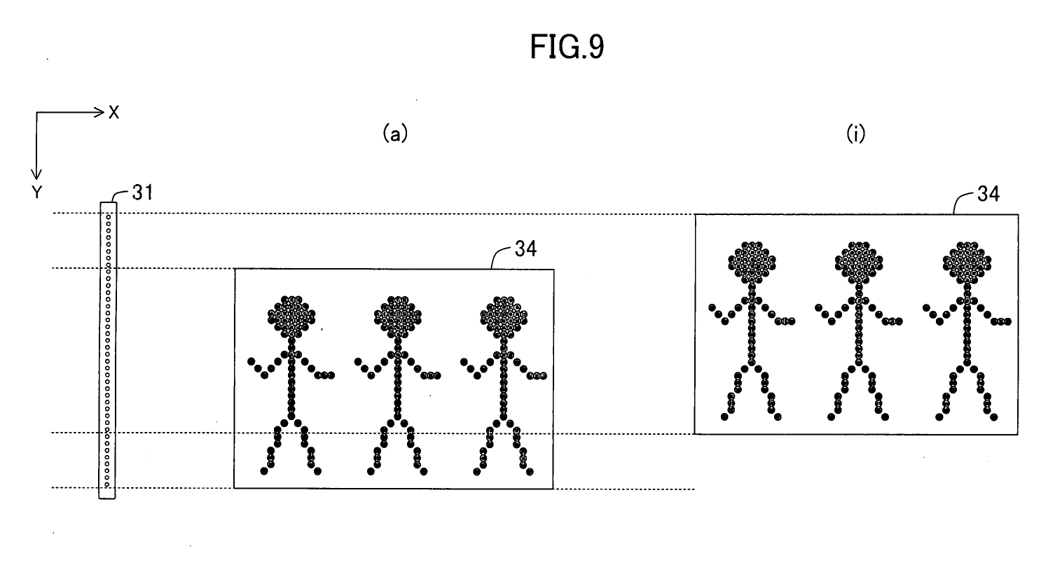

In this example, the number of dots necessary for the image region along the vertical direction is 32 but the number of nozzles of the line head 31 is 40. Therefore, even when the line head 31 is shifted along the Y direction, the same image can be recorded as far as 32 nozzles 33 are disposed above the roll sheet 34. In this example, the relative position between the roll sheet 34 and the line head 31 can be any of nine positions (a) through (i) shown in FIG. 8. In other words, the number of positions of the nozzle combination used nozzles is 9. FIG. 9 is a diagram for showing the relative positions obtained by changing the position of the roll sheet 34 against the recording head 31. The positions (a) and (i) of FIG. 9 respectively correspond to the positions (a) and (i) of FIG. 8. It is understood from FIG. 9 that the same image can be recorded by using a different position of the nozzle combination.

However, if merely the line head 31 is shifted along the Y direction without changing the position of the used nozzle combination, the recorded image is shifted along the Y direction correspondingly to the shift of the line head 31. Therefore, in this embodiment, the image data is converted in accordance with the shift of the line head 31, so as to change the position of the combination of the used nozzle. Specifically, the image data is converted so that the image to be recorded can be shifted along the opposite direction to the shifting direction of the line head 31 by the same shifting amount.

In this example, the shift of the line head 31 and the conversion of the image data are performed every time the line head 31 is subjected to the recovery operation. In other words, the shift of the line head 31 and the conversion of the image data are performed between a time before the movement of the line head 31 toward the recovery system mechanism 21 and a time after the movement of the line head 31 to the recording position from the vicinity of the recovery system mechanism 21. However, the time when the shift of the line head 31 and the conversion of the image data are performed is not particularly specified, and for example, they may be performed every time a predetermined number of images are recorded. Also, the timing of the shift of the line head 31 and the like may be appropriately specified by a user.

In this example, when the line head 31 moves toward the recovery system mechanism 21, the head position change unit 52 of the managing device 4 changes the set position of the line head 31 successively to the positions (a) through (i) of FIG. 8 in this order. On the other hand, the image data conversion unit 51 converts the image data for shifting the image to be recorded in accordance with the set position changed by the head position change unit 52, so that the recording position on the roll sheet 34 cannot be changed through the change of the set position. For example, when the set position of the line head 31 prior to the recovery operation is the position (a), the head position change unit 52 selects the position (b) as the changed set position. In other words, the head position change unit 52 shifts the set position of the line head 31 downward of FIG. 8 by a distance corresponding to one nozzle. Then, the image data conversion unit 51 converts the image data so that the image to be recorded can be shifted upward of FIG. 8 by a distance corresponding to one nozzle.

Information of the changed set position is sent to the motor control unit 16 of the recording device 5, and the motor control unit 16 controls the CR motor 11 on the basis of the output signal from the linear encoder 10 so as to place the line head 31 in the changed set position. As a result, the line head 31 is set in the changed set position after the recovery operation. Also, the converted image data is sent to the head control unit 15 and the head control unit 15 controls the line head 31 on the basis of the converted image data. As a result, the same images are formed in different positions of the nozzles before and after the recovery operation.

In this manner, in the recording system of this embodiment, the line head 31 is shifted along the Y direction and the image data is converted so as to shift the image to be recorded along the opposite direction by the same amount. Therefore, the same images can be formed by using different combinations of nozzles. Accordingly, the dispersion of the discharging frequencies among the nozzles is reduced, so that the lifetime of the line head 31 can be elongated and the line head 31 can be efficiently used.

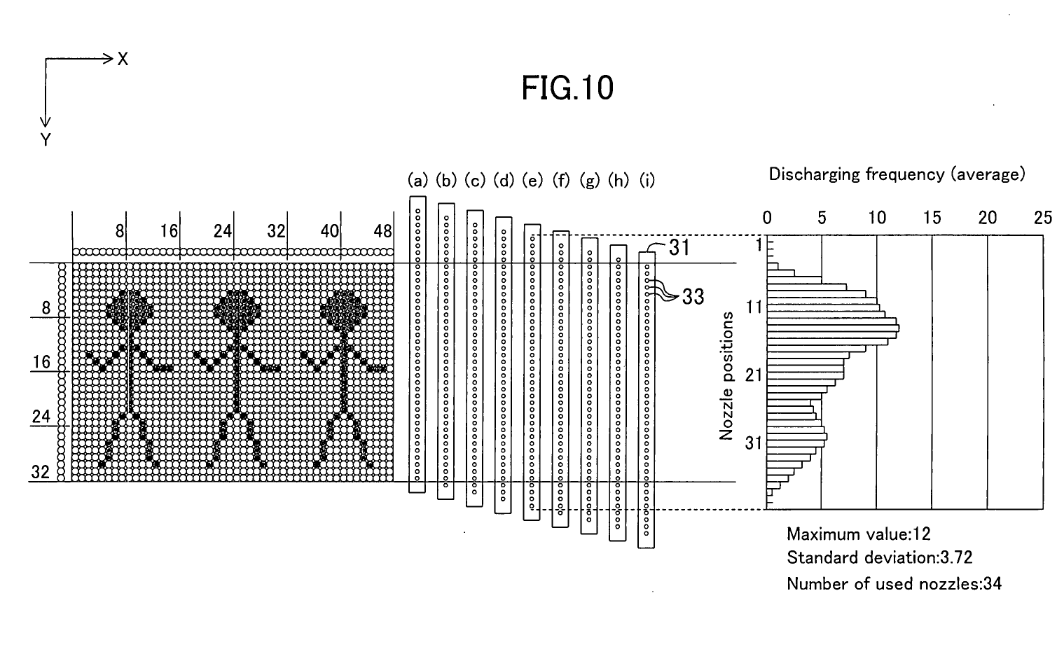

Next, the effects of the recording system of this embodiment will be specifically described on the basis of the exemplified image. FIG. 10 shows a graph of average discharging frequencies of the respective nozzles obtained when the image shown in FIG. 10 is continuously recorded with the set position of the line head 31 shifted successively to the positions (a) through (i). It is understood from comparison between FIG. 10 and FIG. 7 that the dispersion of the discharging frequencies is reduced by changing the set position of the line head 31. In these drawings, the “maximum value” means the discharging frequency of a nozzle with the maximum discharging frequency, and the “number of used nozzles” means the number of nozzles that discharge the ink at least once in recording the image. The “standard deviation” means the dispersion of the discharging frequencies among the nozzles.

The maximum value of the discharging frequency is 21 when the position of the line head 31 is not changed (as shown in FIG. 7), but the maximum value is reduced to 12 by changing the position of the line head 31 (as shown in FIG. 10). In general, the lifetime of a head is regarded to depend upon the maximum value of the discharging frequencies, and therefore, according to this embodiment, the lifetime of the line head is theoretically increased by 21/12 times, i.e., 1.7 times.

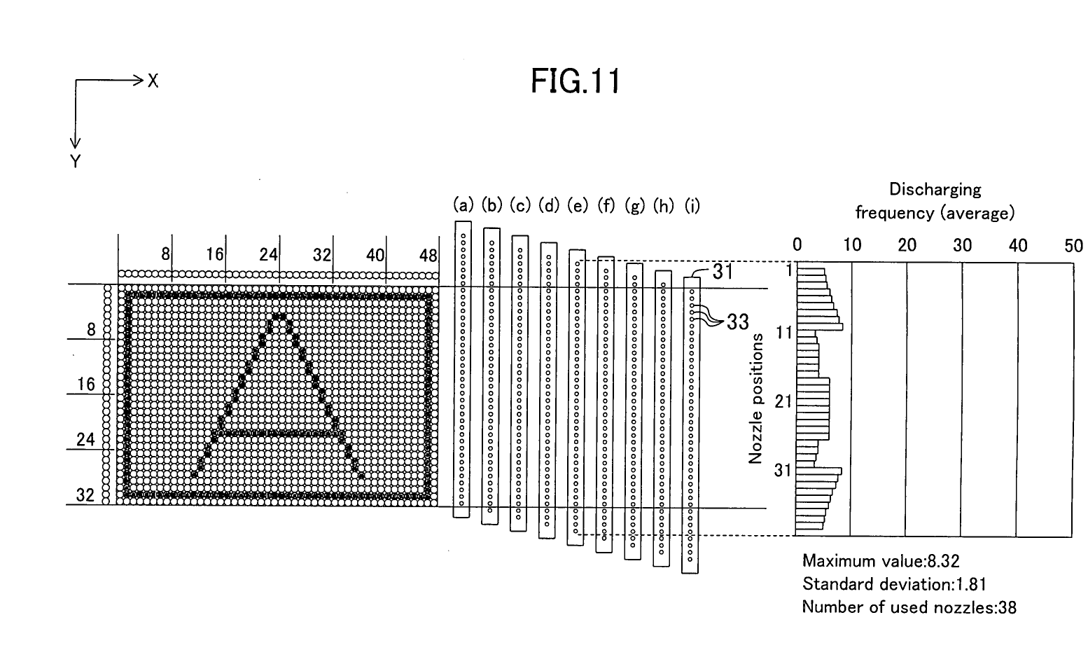

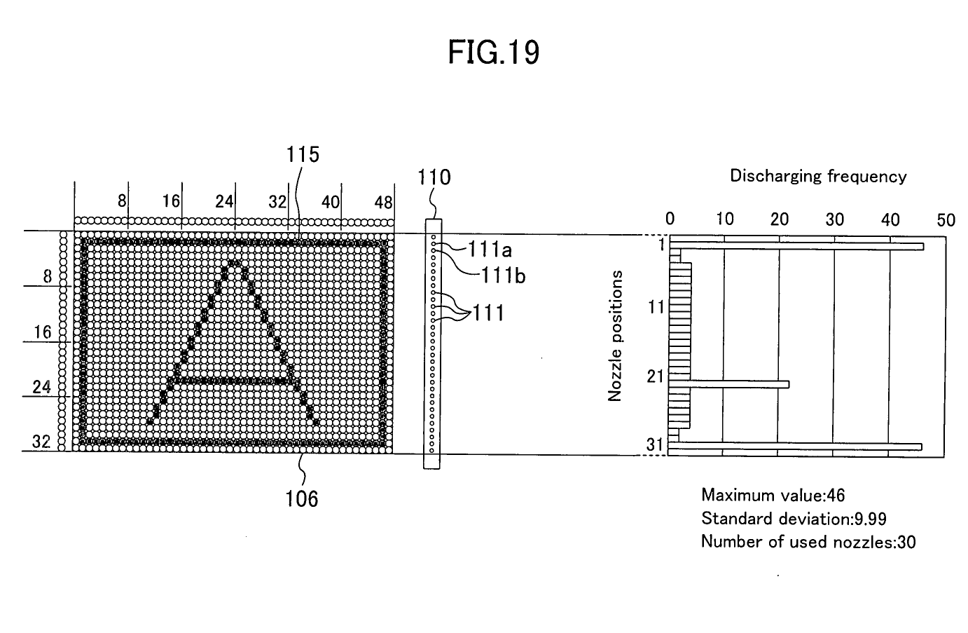

The recording system of this embodiment exhibits a remarkable effect particularly when an image including a line extending along the X direction, such as a voucher, is recorded. FIG. 11 shows average discharging frequencies of the respective nozzles obtained when an image shown in FIG. 11 is recorded with the set position of the line head 31 successively changed to the positions (a) through (i). As is obvious from FIGS. 11 and 19, the dispersion of the discharging frequencies is largely reduced by shifting the line head 31 along the Y direction. Also, as is understood from FIG. 19, if the set position of the line head 31 is not changed, a nozzle 111a used for recording a line extending along the X direction should discharge the ink as frequently as 46 times, and hence, the maximum value of the discharging frequency is as large as 46. On the other hand, a nozzle 111b adjacent to the nozzle 111a discharges the ink merely twice. Therefore, the dispersion of the discharging frequencies among the nozzles is very large. On the contrary, as is obvious from FIG. 11, a nozzle used for recording a line extending along the X direction is appropriately changed by appropriately changing the set position of the line head 31, and therefore, the average maximum value of the discharging frequency is largely reduced to 8.32. As a result, the lifetime of the line head 31 is theoretically increased by 46/8.32 times, i.e., 5.5 times. In this manner, in the case where specific nozzles should concentrically discharge the ink for forming an image to be recorded, such as the case where the image to be recorded includes a ruled line or a border line, or includes a large number of columns as in a voucher, the recording system of this embodiment particularly exhibits the remarkable effect.

Also, in the creation of vouchers, a plurality of images that are common in at least a part of the image contents are continuously recorded, and hence, the discharging frequencies of the nozzles tend to disperse. In the recording system of this embodiment, however, even in the case where a plurality of images that are common in at least a part of the image contents are continuously recorded, the dispersion of the discharging frequencies can be reduced for the aforementioned reason.

As described so far, according to this embodiment, the maximum discharging frequency of the nozzles of the line head 31 can be reduced, and therefore, the lifetime of the line head 31 can be elongated. Furthermore, the dispersion of the discharging frequencies among the nozzles can be suppressed, and the number of used nozzles can be increased. Therefore, the nozzles of each line head 31 can be comparatively uniformly used, so as to prevent merely a part of nozzles from degrading early. As a result, the line head 31 can be efficiently used.

Also, in general, the viscosity of an ink contained in a nozzle is increased and the ink discharging performance is unstable as the time interval of ink discharging from the nozzle is large. However, in the line head 31 of this embodiment, the frequencies of the uses of the respective nozzles are more averaged, and hence, the time intervals of the ink discharging from the respective nozzles 33 are averaged. Accordingly, a difference in the viscosity of the inks contained in the respective nozzles 33 at the time of the ink discharging is reduced, so as to stabilize the ink discharging performance as a whole.

In the above-described embodiment, the position of the line head 31 is changed at the time of the recovery operation, and therefore, there is no need to suspend the recording operation of the recording device 5 merely for changing the position of the line head 31. Accordingly, vouchers and the like can be efficiently created without causing a loss in the recording processing.

Since the CR motor 11 for moving the line head 31 toward the recovery system mechanism 21 is directly used as a driving mechanism for changing the position of the line head 31, there is no need to provide a dedicated driving mechanism for changing the position of the line head 31. Therefore, there is no need to additionally provide a component, resulting in suppressing the increase of the number of components.

### Embodiment 2

In Embodiment 2, in changing the combination of used nozzles of the line head 31, image data is converted so as not only to shift an image along the Y direction but also to rotate the image.

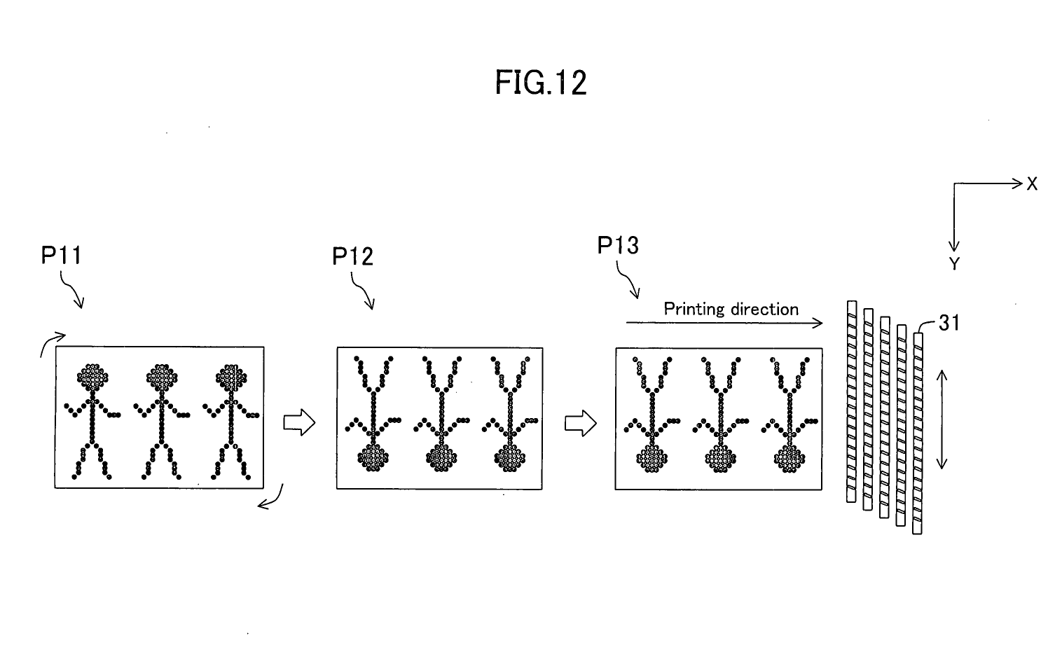

As shown in FIG. 12, an image data conversion unit 51 of this embodiment converts image data so that an image to be recorded can be rotated by 180 degrees (as shown as a position P12 in FIG. 12) as well as shifted along the Y direction (as shown as a position P13 in FIG. 12). The image can be appropriately rotated, and the image may be rotated every time it is shifted along the Y direction (namely, every time the set position of the line head 31 is changed) or rotated regardless of the shift of the image along the Y direction.

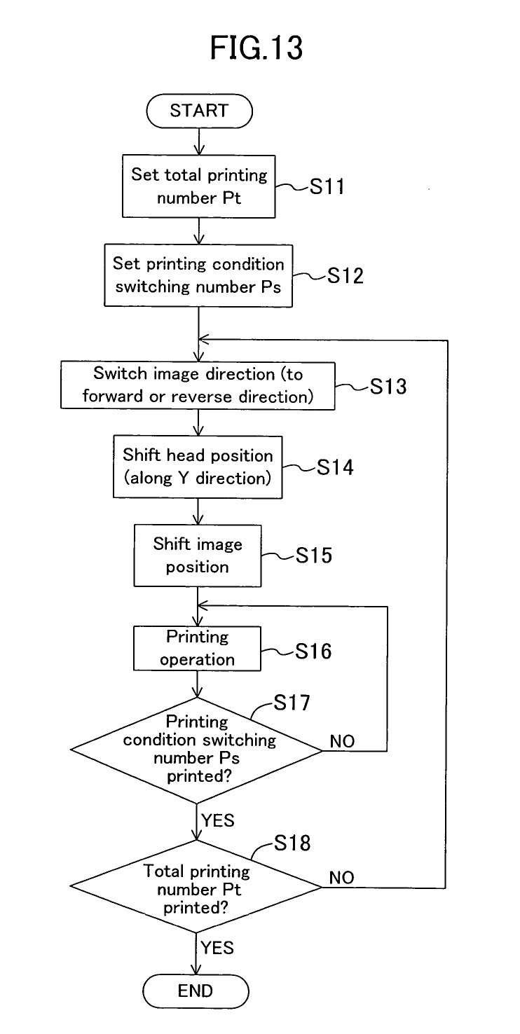

Referring to FIG. 13, the recording operation of this embodiment will be described.

Prior to the recording operation, in step S11, a total printing number Pt is first set. Next, in step S12, a printing condition switching number Ps is set. The step S12 corresponds to a procedure for setting a condition for image data conversion. In this embodiment, the image data is converted every time the recording of the given number Ps of images is finished.

When the setting of steps S11 and S12 is completed, the flow proceeds to step S13 where an image direction is switched. In this embodiment, the image is rotated by 180 degrees. Next, the flow proceeds to step S14 where the position along the Y direction of the line head 31 is shifted. Then, in step S15, the position along the Y direction of the image is changed in accordance with the positional shift of the line head 31. Specifically, the image to be formed after the rotation is shifted in the opposite direction to the shifting direction of the line head 31 by the same amount as the shift of the line head 31.

Next, in step S16, the image data is converted so as to record the rotated and shifted image, and the printing operation (recording operation) is performed on the basis of the converted image data. When the printing operation is completed, it is determined in step S17 whether or not the printing operation of the given number Ps of times has been completed, and when NO, the flow returns to step S16 so as to repeat the printing operation. On the other hand, when it is determined as a result of the determination of step S17 that the printing operation of the given number Ps of times has been completed, the flow proceeds to step S18 where it is determined whether or not the printing operation of the total printing number Pt of times has been completed. When it is determined as a result that the printing operation of the total printing number Pt of times has not been completed, the flow returns to step S13, so as to rotate the image (in step S13), shift the line head 31 along the Y direction (in step S14), shift the image along the Y direction (in step S15), and perform the printing operation by using a different combination of nozzles (in step S16). On the other hand, when it is determined in step S18 that the printing operation of the total printing number Pt of times has been finished, the whole printing is completed.

According to this embodiment, not only the set position of the line head 31 is changed but also the image is rotated, and therefore, the lifetime of the line head 31 can be further elongated and the line head 31 can be more efficiently used.

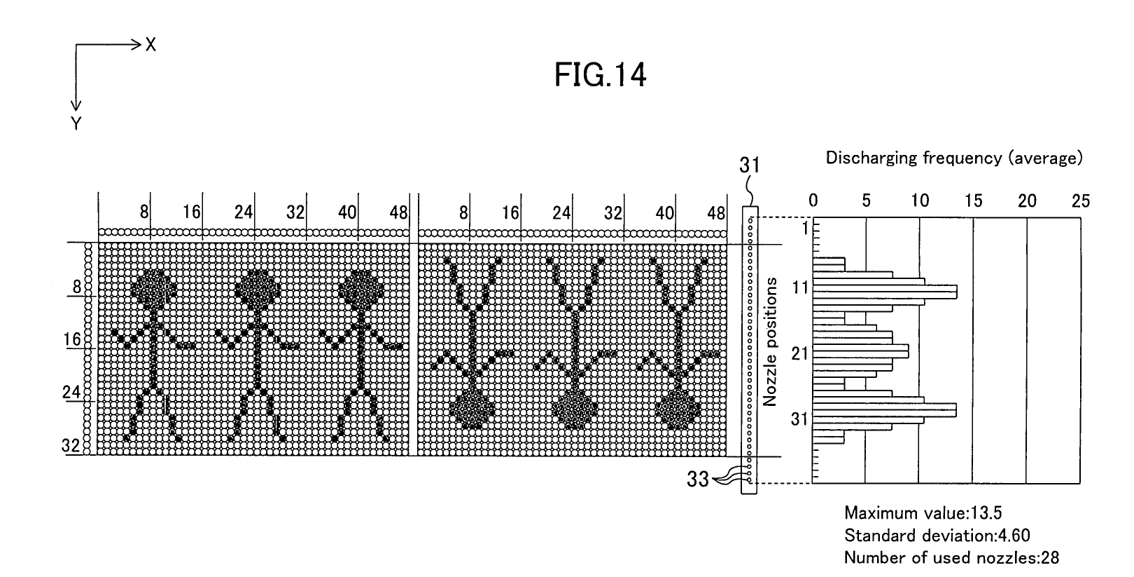

Next, the effect of this embodiment will be specifically described on the basis of an exemplified image. FIG. 14 is a graph for showing the average discharging frequencies of the respective nozzles obtained when the image is rotated by 180 degrees. It is understood from comparison between FIG. 7 and FIG. 14 that the dispersion of the discharging frequencies among the nozzles can be reduced and the maximum discharging frequency can be reduced also by simply rotating the image by 180 degrees. Thus, the lifetime of the line head 31 can be elongated to some extent merely by converting the image data so as to rotate the image by 180 degrees. In this example, the lifetime of the line head 31 is theoretically increased by 21/13.5 times, i.e., 1.5 times, by rotating the image.

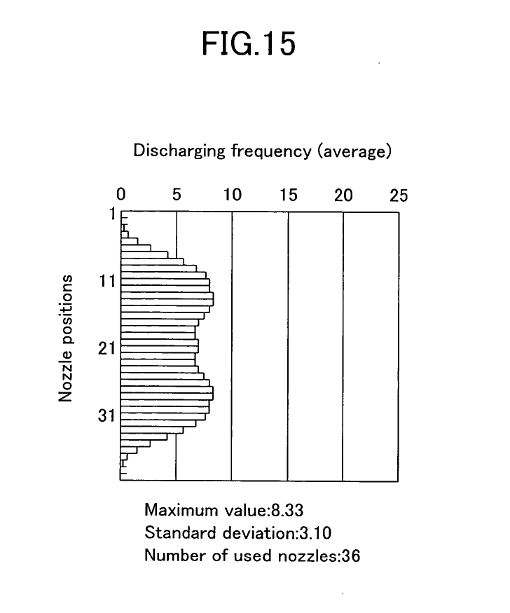

In this embodiment, however, since the image is not only rotated by also shifted along the Y direction, the lifetime of the line head 31 can be further elongated. FIG. 15 is a graph for showing the average discharging frequencies of the respective nozzles obtained when the image is rotated and the position of the line head 31 is shifted respectively to the positions (a) through (i). As is understood from FIG. 15, the maximum value of the average discharging frequencies of the nozzles is 8.33, and thus, the lifetime of the line head 31 can be theoretically increased by 21/8.33 times, i.e., 2.5 times. Also, the dispersion of the discharging frequencies among the nozzles can be further reduced.

Although the image is rotated by 180 degrees in the aforementioned embodiment, the rotation angle of the image is not limited to 180 degrees. The rotation angle may be appropriately set in accordance with the content of the image.

### Alternative Embodiments

The recording device 5 of each of the aforementioned embodiments uses a combination of line heads 31 of the four colors, but merely one line head may be used. The recording head according to the present invention may be one for recording a single color image. Alternatively, the recording head may be one including a plurality of line heads for discharging an ink of the same color for performing gray scale printing.

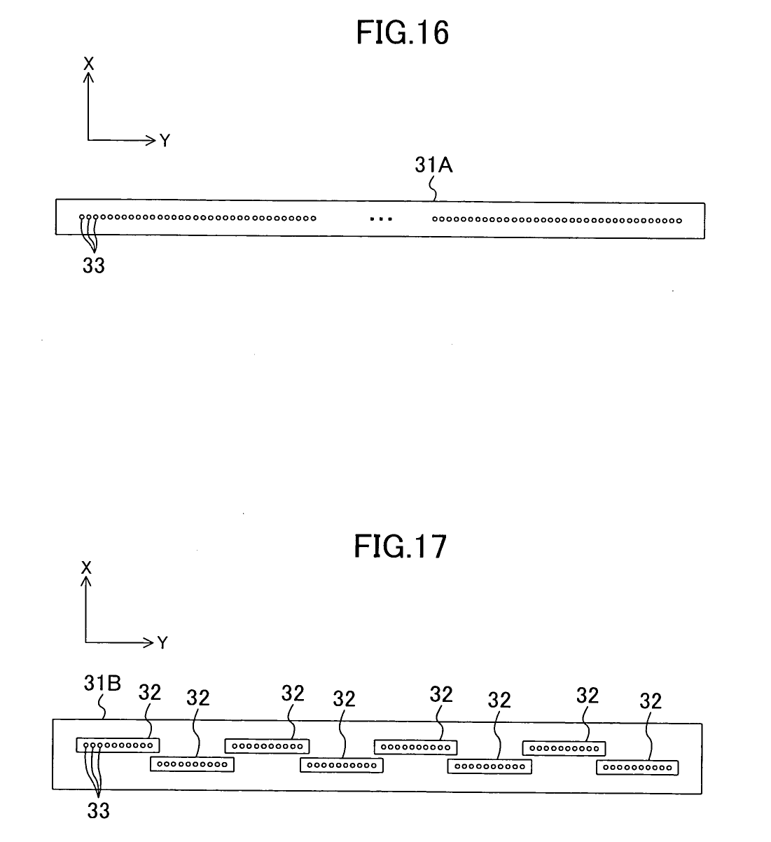

The structure of the recording head is not limited to that of the line head 31 described in each of the aforementioned embodiments as far as it is an inkjet recording head having, on at least a part thereof, a plurality of nozzles arranged along the Y direction. For example, it may be a recording head 31A shown in FIG. 16 having a string of nozzles arranged along the Y direction. Alternatively, it may be a recording head 31B shown in FIG. 17 including unit heads 32 arranged in a zigzag manner along the Y direction.

The longitudinal direction (a first direction) of the line head 31 need not be orthogonal to the transferring direction (a second direction) of the recording medium as far as they cross each other.

In each embodiment, the conversion of the image data and the positional shift of the line head 31 are performed by the managing device 4 present outside the recording device 5. However, one or both of the conversion of the image data and the positional shift of the line head 31 may be performed by the recording device 5 itself. One or both of the image data conversion unit 51 and the head position change unit 52 may be provided in the recording device 5.

In each embodiment, the relative positions of the recording head and the recording medium are changed by moving the recording head. However, the recording medium may be moved instead with the recording head fixed. Alternatively, both the recording head and the recording medium may be moved.

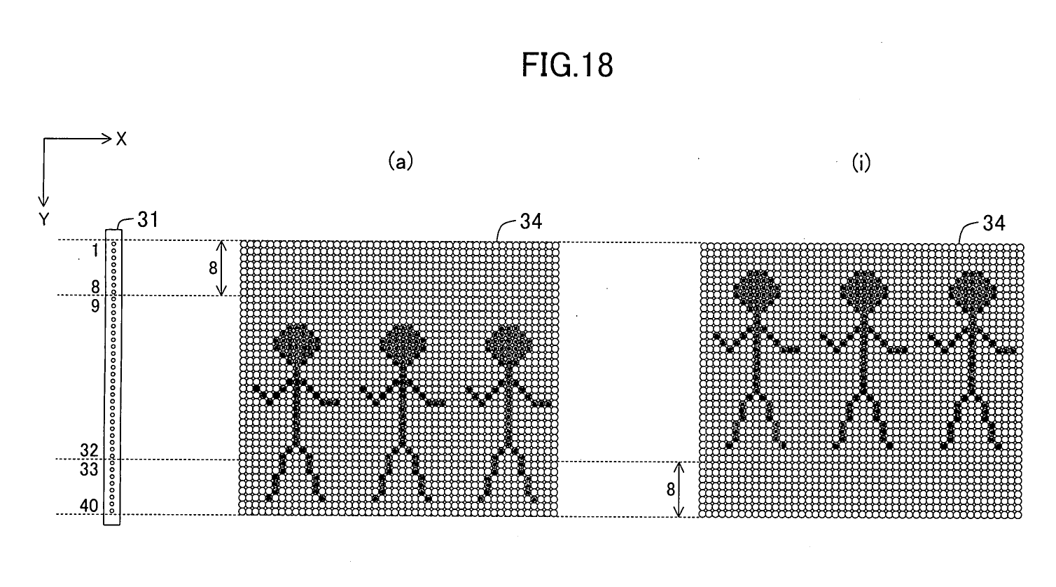

Alternatively, without changing the relative positions of the recording head and the recording medium, the image to be formed may be shifted along the Y direction so as to change the combination of used nozzles. For example, as shown in FIG. 18, without changing the relative positions of the line head 31 and the roll sheet 34, the used nozzles alone may be changed. In this case, however, the recording position on the roll sheet 34 is changed. Therefore, this modification is suitably employed when an accurate recording position is not severely demanded.

In each embodiment, the recording medium is not limited to the roll sheet 34 but may be cut paper. The material of the recording medium is not limited to paper but may be any of other materials such as a building material, a sheet metal, a corrugated fiberboard and plastic. The shape of the recording medium is not limited to a square but may be any of other shapes such as a regular polygonal shape and a circular shape.

As described so far, the present invention exhibits the remarkable effect particularly when the same image is recorded on a large scale. Specifically, the present invention is particularly effective for repeatedly recording the same image, for example, for recording labels on CD-ROMs or DVD-ROMs or creating vouchers.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within meets and bounds of the claims, or equivalence of such meets and bounds are therefore intended to embraced by the claims.

1. An inkjet recording system comprising:
an inkjet recording head having a plurality of nozzles arranged along a first direction;
a moving mechanism for supporting said recording head and/or a recording medium and moving said recording head and said recording medium relatively to each other along a second direction not parallel to said first direction in a recording operation;
a controller for accepting image data for recording an image by allowing said nozzles of said recording head to discharge an ink and for controlling said recording head and said moving mechanism for recording said image on said recording medium; and
an image data converter for converting said image data,
wherein said image is recorded by a nozzle combination of which nozzles are a part of said nozzles that said inkjet recording head has and which includes nozzles arranged in a string along said first direction,
said image data converter converts said image data so as to shift a position of said nozzle combination along said first direction, and
said controller accepts said converted image data and controls said recording head for recording said image with said position of said nozzle combination shifted along said first direction.

2. The inkjet recording system of claim 1,
further comprising position changing means for changing a relative position along said first direction of said recording head against said recording medium by a given distance in a non-recording operation,
wherein said image data converter converts said image data in such a manner that said image is shifted along a direction opposite to a direction of the relative movement between said recording head and said recording medium by a distance equal to said given distance.

3. The inkjet recording system of claim 1,
further comprising a carriage motor for driving said recording head along said first direction.

4. The inkjet recording system of claim 2, further comprising:
a recovery system mechanism provided in a position away at least along said first direction from a recording position of said recording head and including at least caps for covering said nozzles of said recording head; and
a driving mechanism for moving said recording head between said recording position and the position of said recovery system mechanism,
wherein said driving mechanism also works as said position changing means.

5. The inkjet recording system of claim 4,
wherein said position changing means changes the relative position along said first direction of said recording head against said recording medium between before moving said recording head toward said recovery system mechanism and after moving said recording head toward said recovery system mechanism and returning said recording head to said recording position.

6. The inkjet recording system of claim 1,
wherein said recording medium is a roll type recording medium,
said moving mechanism includes a feeding mechanism for feeding said roll type recording medium along said second direction, and
said image data converter converts said image data when said roll type recording medium is exchanged.

7. The inkjet recording system of claim 2,
wherein said recording medium is a roll type recording medium,
said moving mechanism includes a feeding mechanism for feeding said roll type recording medium along said second direction, and
said position changing means changes the relative position along said first direction of said recording head against said recording medium when said roll type recording medium is exchanged.

8. The inkjet recording system of claim 1,
wherein said image includes a line extending along said second direction.

9. The inkjet recording system of claim 1,
wherein a plurality of images at least partly common in image contents are continuously recorded.

10. The inkjet recording system of claim 1,
wherein said image data converter converts said image data in such a manner that said image is shifted along said first direction and is rotated.

11. The inkjet recording system of claim 10,
wherein said image data converter rotates said image by 180 degrees.

12. An inkjet recording method comprising:
a recording step of moving an inkjet recording head having a plurality of nozzles arranged along a first direction and a recording medium relatively to each other along a second direction not parallel to said first direction and recording, on the basis of image data for recording a given image, said image on said recording medium by using said recording head by allowing said nozzles of said recording head to discharge an ink; and
an image data converting step of converting said image data,
wherein said image is recorded by a nozzle combination of which nozzles are a part of said nozzles that said inkjet recording head has and which includes nozzles arranged in a string along said first direction,
in said image data converting step, said image data is converted so as to shift a position of said nozzle combination along said first direction, and
in said recording step, said image is recorded by using said recording head with said position of said nozzle combination shifted along said first direction on the basis of said converted image data after converting said image data in the image data converting step.

13. The inkjet recording method of claim 12,
further comprising a position changing step of changing a relative position along said first direction of said recording head against said recording medium by a given distance,
wherein, in the image data converting step, said image data is converted in such a manner that said image is shifted along a direction opposite to a direction of the relative movement of said recording head by a distance equal to said given distance.

14. The inkjet recording method of claim 12,
wherein, in the image data converting step, said image data is converted in such a manner that said image is shifted along said first direction and is rotated.
